(19) United States
(12) Patent Application Publication
(10) Pub. No.: US 2015/0130342 A1
(43) Pub. Date: May 14, 2015

(54) FILE CABINET ELASTIC FOOTPRINT EXTENDER

(71) Applicant: Ralph Lipsey BARNETT, Wilmette, IL (US)

(72) Inventor: Ralph Lipsey BARNETT, Wilmette, IL (US)

(21) Appl. No.: 14/480,005

(22) Filed: Sep. 8, 2014

Related U.S. Application Data
(60) Provisional application No. 61/874,493, filed on Sep. 6, 2013.

(51) Int. Cl. A47B 97/00; F16M 13/00; F16M 11/00

(52) U.S. Cl. CPC A47B 97/00; F16M 11/00; F16M 13/00; A47B 2097/008; F16M 2200/08; F16M 2200/04
USPC 312/351.1; 248/346.03; 248/346.05

(57) ABSTRACT

The present invention provides a baseplate that can be retrofit to a file cabinet, furniture, appliances or other large objects to improve a tip resistance of the object to minimize a tipping danger.

### CROSS REFERENCE TO RELATED APPLICATION

This application claims the benefit of U.S. Provisional Patent Application Ser. No. 61/874,493, filed on 6 Sep. 2013. The co-pending Provisional Patent Application is hereby incorporated by reference herein in its entirety and is made a part hereof, including but not limited to those portions which specifically appear hereinafter.

### BACKGROUND OF THE INVENTION

1. Field of the Invention

This invention is directed to an apparatus to prevent file cabinets, furniture and other large items from tipping over and causing injury.

2. Discussion of Related Art

File cabinets are inherently dangerous because the sliding of drawers changes a center of gravity of the entire cabinet and when the center of gravity is not over the footprint of the cabinet, the cabinet can easily tip over. This inherent danger can be increased under reasonably foreseeable circumstances including: overloading cabinets; pulling downward on extended drawers; pulling horizontally on open or closed drawer hardware or cabinet structure; people ensnared on the cabinet structure while walking away from the unit; impacting or pushing forward on a backside of the cabinet by people or vehicles such as forklifts; mounting cabinets on non-level surfaces; and impact from rapidly opening drawers against stops. Known methods of increasing the stability of the file cabinets include: bolting the cabinets to the floor and/or wall; adding counterweights; gang bolting cabinets side-to-side or back-to-back; locating the file cabinet beneath a shelf or other horizontal surface that blocks the cabinet's ability to tilt; and interlock systems that permit only one drawer to be open at a time. Bolting, ganging and under mounting work well to minimize tipping; however, these methods immobilize cabinets and inhibit relocation within an office. Counterweights and interlocks only provide modest improvement in overturning resistance and cannot be retrofit to traditional file cabinets that have multi-decade life spans.

### SUMMARY OF THE INVENTION

A general object of the invention is to extend a footprint of a file cabinet to prevent the cabinet from tipping over. Another object of this invention is that the invention can be retrofit to a traditional file cabinet with or without safety features.

In a preferred embodiment of this invention, the cabinet includes a housing with a plurality of drawers and a footprint. The cabinet further comprises a baseplate connected to a bottom of the housing that extends beyond an edge of the footprint of the file cabinet to shift an axis of rotation in front of the cabinet. In a preferred embodiment, the baseplate comprises steel, plastic or any other type of durable material that is capable of withstanding the force of a tipping file cabinet. In a preferred embodiment, the material provides an elastic, spring-like characteristic to the baseplate. In a preferred embodiment, the baseplate comprises a thickness ranging from ⅛ inch to ¼ inch. However, the thickness may vary from this range depending on the application and may measure 1 inch or more.

### BRIEF DESCRIPTION OF THE DRAWINGS

These and other objects and features of this invention will be better understood from the following detailed description taken in conjunction with the drawings, wherein:

FIG. 1 is a perspective view of a file cabinet with an elastic footprint extender according to an embodiment of this invention.

FIG. 2 is another perspective view of the elastic footprint extender of FIG. 1.

FIG. 3 is another perspective view of the elastic footprint extender of FIG. 1.

FIG. 4 is a schematic view of a file cabinet with an elastic footprint extender according to an embodiment of this invention.

FIG. 5 is a schematic view of the file cabinet and the elastic footprint extender of FIG. 4 tipping over.

FIG. 6a is a schematic view of a test set up for a file cabinet with an elastic footprint extender according to an embodiment of this invention.

FIG. 6b is a schematic view of a test set up for the file cabinet of FIG. 6a without the elastic footprint extender.

FIG. 7a is a schematic view of a test set up for a file cabinet with an elastic footprint extender according to an embodiment of this invention.

FIG. 7b is a schematic view of a test set up for the file cabinet of FIG. 7a without the elastic footprint extender.

FIG. 8a is a schematic view of a test set up for a file cabinet with an elastic footprint extender according to an embodiment of this invention.

FIG. 8b is a schematic view of a test set up for the file cabinet of FIG. 8a without the elastic footprint extender.

FIG. 9a is a schematic view of a test set up for a file cabinet with an elastic footprint extender according to an embodiment of this invention.

FIG. 9b is a schematic view of a test set up for the file cabinet of FIG. 9a without the elastic footprint extender.

### DETAILED DESCRIPTION OF PREFERRED EMBODIMENTS

The present invention provides a baseplate 10 which can be retrofit to a file cabinet 20 to prevent the file cabinet 20 from tipping over and possibly causing injuries.

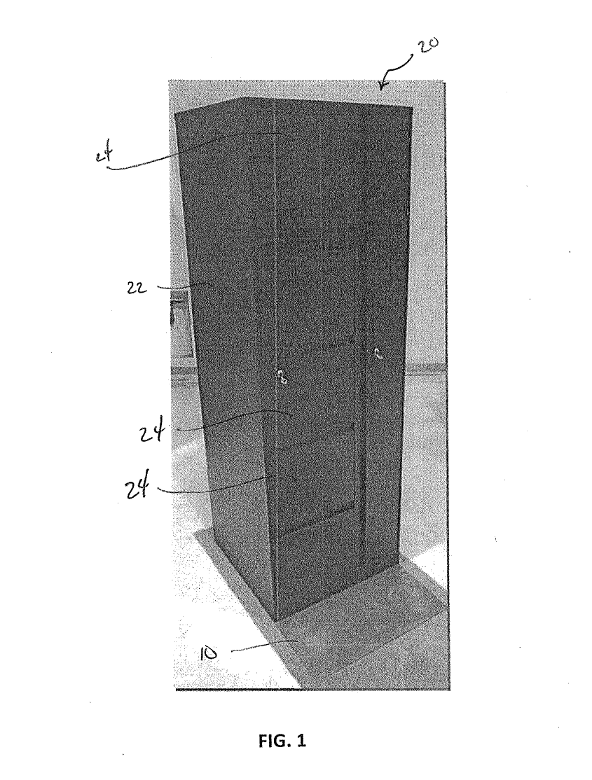

FIG. 1 shows an exemplary file cabinet 20 to which the baseplate 10 of this invention may be attached. This file cabinet 20 includes a housing 22 with a plurality of horizontal pull drawers 24 and a wardrobe door 26. In this embodiment, the file cabinet includes five drawers 24 and one wardrobe door 26. However, the baseplate 10 of this invention may be used with any type of file cabinet having any number of drawers 24 and with or without the wardrobe door 26. Alternatively, the base plate may be used with any type of furniture, appliance or large object that may be prone to tipping over including, but not limited to, bookcases, televisions, and dressers.

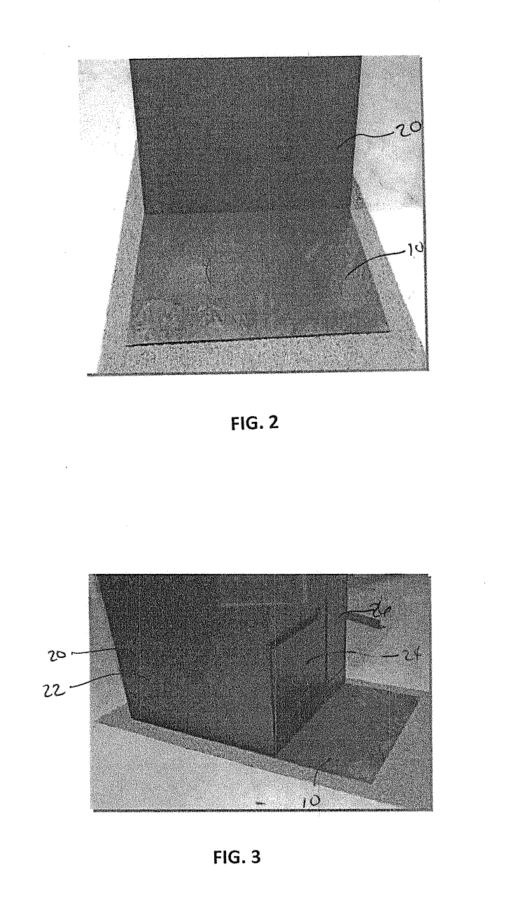

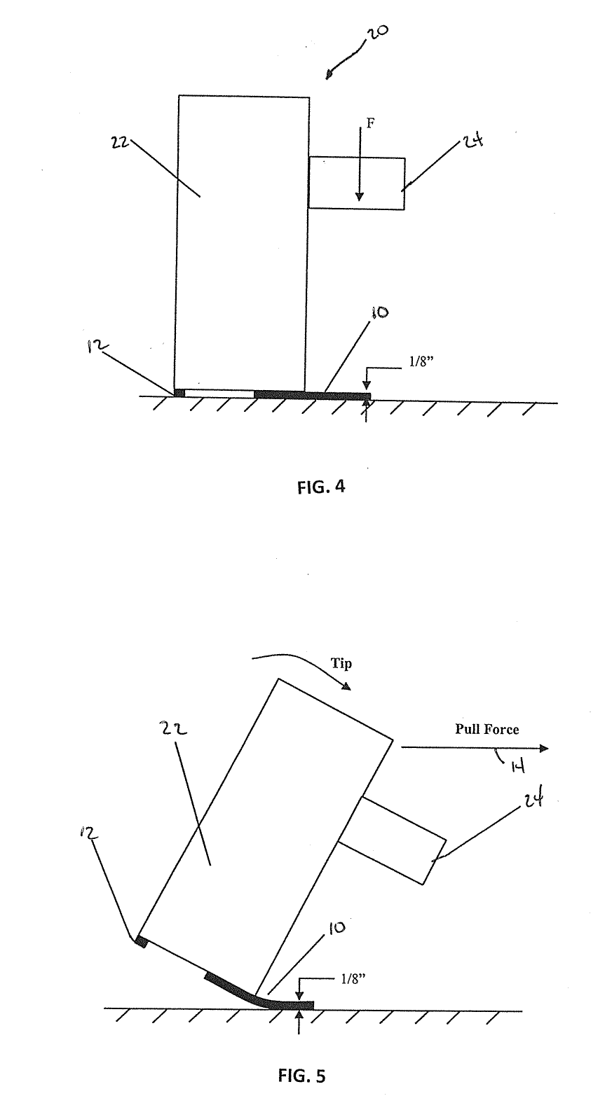

FIGS. 1-3 show an embodiment of the baseplate 10 of this invention from different views. FIG. 4 shows a schematic view of the baseplate 10 of an embodiment of this invention with one drawer 24 extending from the file cabinet 20. In this embodiment, the baseplate 10 comprises an elastic plate with a thickness of ⅛ inch which extends approximately 12 inches beyond at least one edge of a footprint of the housing. However, the baseplate 10 may comprise any dimensions including a range of thicknesses from 1/16 inch to 1 inch or more depending on the application. Furthermore, the baseplate 10 may extend any length beyond the edge of the cabinet, for example from 1 inch to 3 feet or more. In a preferred embodiment, the baseplate extends from the edge of the cabinet in the same direction as the drawers 24 extend. Alternatively, the base plate 10 may extend beyond multiple edges of the footprint. In an embodiment of this invention, the baseplate preferably includes an elastic characteristic to act like a spring and is durable and strong to withstand rotation forces generated by a tipping file cabinet 20. For example, the baseplate 10 may comprise steel, plastic, aluminum or any other type of material capable of withstanding the rotation force of a tipping cabinet. In a preferred embodiment, this invention may further include a leveling screw 12 positioned opposite to the baseplate 10. Alternatively, the baseplate 10 may extend an entire depth of the cabinet 20.

Without the baseplate 10 of this invention, an axis of rotation of the file cabinet 20 is normally located at a bottom front edge of the file cabinet 20. With the baseplate 10 the axis of rotation is shifted forward in front of the cabinet 20, increasing a restoring moment and improving a forward stability limit. In an embodiment of this invention, a three to five-fold increase in tip resistance is typical. FIG. 5 shows a schematic representation of the shifting forward of the axis of rotation.

The baseplate 10 of this invention also provides a second significant safety property. The elastic behavior of the baseplate 10 provides a precursor of impending instability. Normally, without the baseplate 10, when a file cabinet begins to tip, a maximum resistance is achieved at incipient liftoff of a lower back edge of the cabinet. After lift-off, an overturning moment continually increases as a tip angle increases. At the same time, a restoring moment of the cabinet continually decreases, resulting in a sudden loss of stability at lift-off With the baseplate 10 of this invention, tip-over does not commence with lift-off Instead, an elastic (deflection) behavior of the cantilevered baseplate gives rise to considerable rotation before a balance point is reached, as shown in FIG. 5. This precursor to tip-over enables an individual to take precautionary measures, such as, releasing from the cabinet, catching the cabinet, unsnagging garments, and/or moving away.

In a preferred embodiment of this invention, the baseplate 10 can be retrofit to an existing file cabinet 20. The baseplate 10 is preferably connected to the bottom of the cabinet 20 with a threaded connection. However, the baseplate 10 may be connected to the file cabinet in other ways including, but not limited to, adhesive and welding. In an alternative embodiment, the baseplate 10 may be integrally formed to the cabinet 20.

### EXPERIMENTAL RESULTS

Test 1: Empty Cabinet with and without a ⅛″ Steel Baseplate:

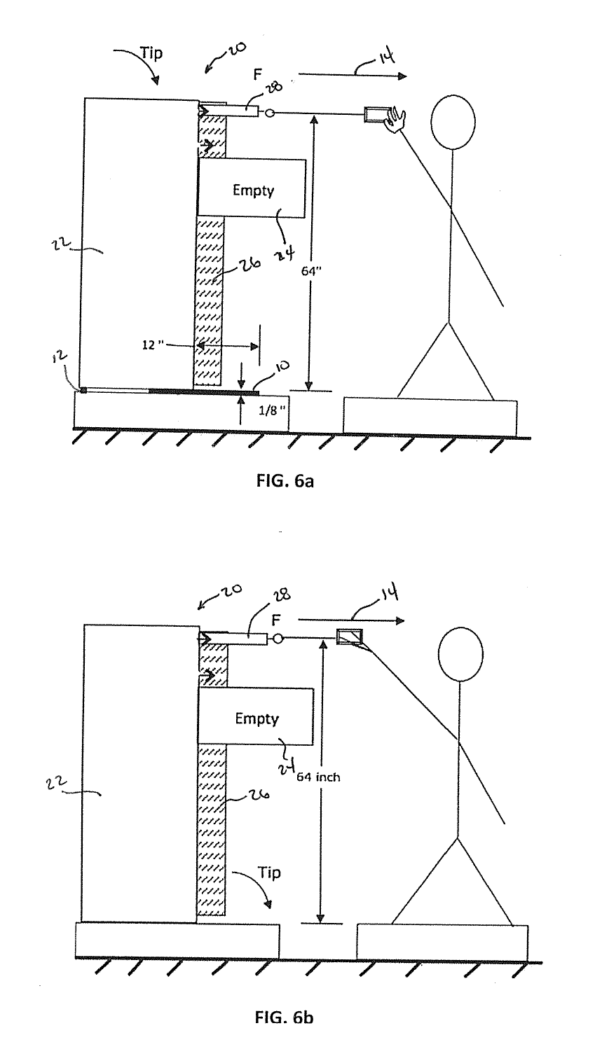

FIGS. 6a-b, show a schematic representation of an experiment illustrating an embodiment of the baseplate 10 of this invention. In this experiment, a Steelcase® brand file cabinet 20 was tested. In FIG. 6a, a steel baseplate 10 was attached to the bottom of the cabinet 20 with 12 inches extending from the front of the cabinet. The model was a tower-vertical, 4 drawer cabinet with a lift-up drawer and a wardrobe door, measuring 24 inches by 24 inches by 65.5 inches tall, weighing 189 lbs. without a counterweight. Test conditions included: a level, carpeted surface; the wardrobe door open; the lift-up drawer open and fully extended; a ⅛ inch steel base plate; the top drawer open and empty; the remaining drawers closed and empty; and a calibrated dynamometer. A tipping force 14 was applied to the cabinet 20 at 64 inches off the ground.

With the baseplate 10 attached to the cabinet 20, as shown in FIG. 6a, the following test data was obtained:

TABLE 1

| Trial No. | Pull Force, to tip |
|---|---|
| 1 | 45.2 lbs. |
| 2 | 44.3 lbs. |
| 3 | 42.7 lbs. |
| 4 | 44.4 lbs. |
| 5 | 44.4 lbs. |
| 6 | 43.8 lbs. |
| 7 | 43.4 lbs. |
| 8 | 43.3 lbs. |
| 9 | 44.5 lbs. |
| 10 | 43.2 lbs. |

The statistical characterization of the test results provide: an average forward tip resistance of 43.92 lbs.; a standard deviation of 0.764 lbs.; a coefficient of variation of 1.74% and a balance angle of 36.33°.

Without the baseplate 10 attached to the cabinet 20, as shown in FIG. 6b, the following test data was obtained:

TABLE 2

| Trial No. | Pull Force, to tip |
|---|---|
| 1 | 18.3 lbs. |
| 2 | 18.0 lbs. |
| 3 | 19.5 lbs. |
| 4 | 18.5 lbs. |
| 5 | 18.9 lbs. |
| 6 | 18.8 lbs. |
| 7 | 18.5 lbs. |
| 8 | 19.1 lbs. |
| 9 | 19.0 lbs. |
| 10 | 18.6 lbs. |

The statistical characterization of the test results provide: an average forward tip resistance of 18.72 lbs.; a standard deviation of 0.432 lbs.; a coefficient of variation of 2.3% and a balance angle of 15.5°.

From these results, it is shown that the baseplate 10 of this invention provides significant improvement in the forward tip resistance.

Test 2: Loaded Drawer with and without a ⅛″ Steel Baseplate:

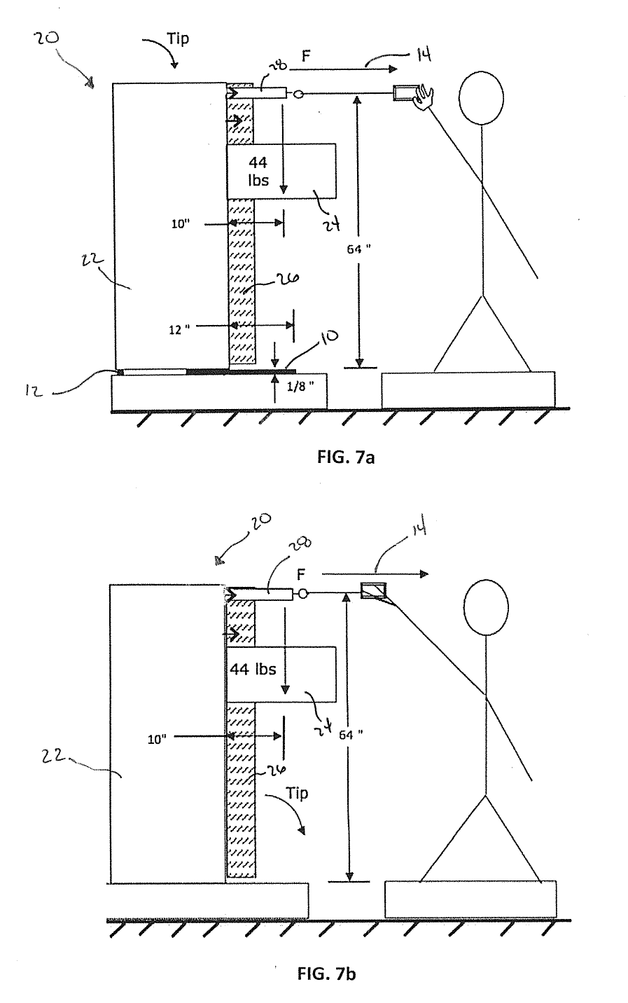

FIGS. 7a-b, show a schematic representation of an experiment illustrating an embodiment of the baseplate 10 of this invention. In this experiment, the same cabinet as tested in Test 1 was tested. In FIG. 7a, a steel baseplate 10 with a thickness of ⅛ inch was attached to the bottom of the cabinet 20 with 12 inches extending from the front of the cabinet. Test conditions included: a level, carpeted surface; the wardrobe door open; the lift-up drawer open and fully extended; a ⅛ inch steel base plate; the top drawer open and loaded with 44 lbs. centered 10 inches from the housing; the remaining drawers closed and empty; and a calibrated dynamometer. A tipping force 14 was applied to the cabinet 20 at 64 inches off the ground.

With the baseplate 10 attached to the cabinet 20, as shown in FIG. 7a, the following test data was obtained:

TABLE 3

| Trial No. | Pull Force, to tip |
|---|---|
| 1 | 35.0 lbs. |
| 2 | 35.3 lbs. |
| 3 | 35.5 lbs. |
| 4 | 34.7 lbs. |
| 5 | 35.6 lbs. |
| 6 | 35.0 lbs. |
| 7 | 36.1 lbs. |
| 8 | 34.5 lbs. |
| 9 | 35.3 lbs. |
| 10 | 35.1 lbs. |

The statistical characterization of the test results provide: an average forward tip resistance of 35.21 lbs.; a standard deviation of 0.461 lbs.; a coefficient of variation of 1.31% and a balance angle of 30.0°.

Without the baseplate 10 attached to the cabinet 20, as shown in FIG. 7b, the following test data was obtained:

TABLE 4

| Trial No. | Pull Force, to tip |
|---|---|
| 1 | 9.1 lbs. |
| 2 | 9.0 lbs. |
| 3 | 9.2 lbs. |
| 4 | 9.3 lbs. |
| 5 | 9.7 lbs. |
| 6 | 9.5 lbs. |
| 7 | 9.7 lbs. |
| 8 | 9.6 lbs. |
| 9 | 9.7 lbs. |
| 10 | 9.1 lbs. |

The statistical characterization of the test results provide: an average forward tip resistance of 9.39 lbs.; a standard deviation of 0.281 lbs.; a coefficient of variation of 2.99% and a balance angle of 9.0°.

From these results, it is shown that the baseplate 10 of this invention provides significant improvement in the forward tip resistance.

Test 3: Empty Cabinet with and without a 1/4″ Steel Baseplate:

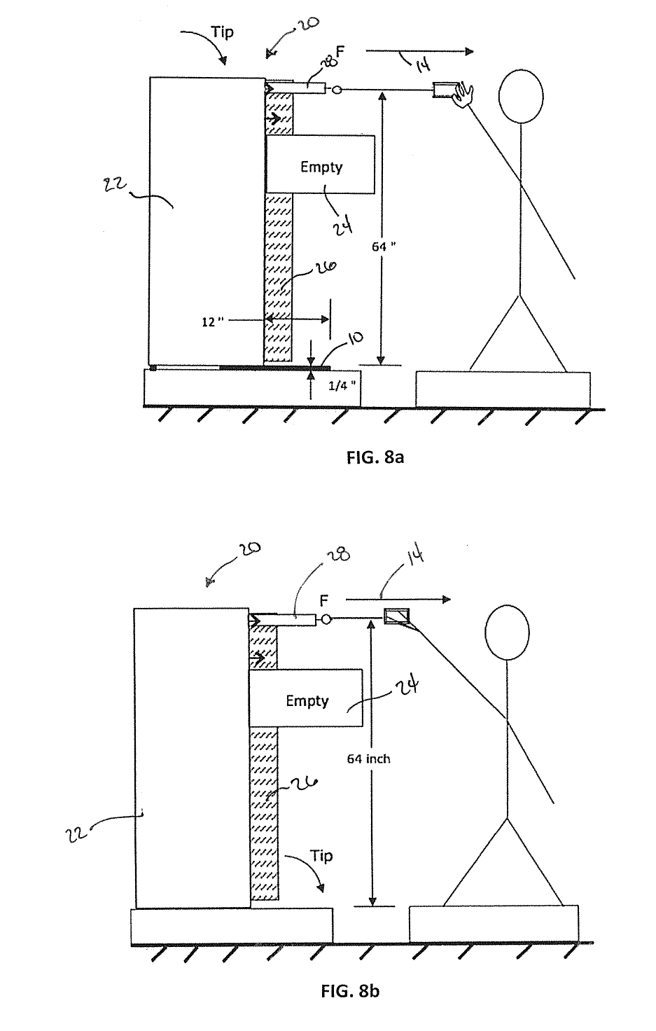

FIGS. 8a-b, show a schematic representation of an experiment illustrating an embodiment of the baseplate 10 of this invention. In this experiment, the same cabinet as tested in Test 1 was tested. In FIG. 8a, a steel baseplate 10 with a thickness of ¼ inch was attached to the bottom of the cabinet 20 with 12 inches extending from the front of the cabinet. Test conditions included: a level, carpeted surface; the wardrobe door open; the lift-up drawer open and fully extended; a ⅛ inch steel base plate; the top drawer open and empty; the remaining drawers closed and empty; and a calibrated dynamometer. A tipping force 14 was applied to the cabinet 20 at 64 inches off the ground.

With the baseplate 10 attached to the cabinet 20, as shown in FIG. 8a, the following test data was obtained:

TABLE 5

| Trial No. | Pull Force, to tip |
|---|---|
| 1 | 54.0 lbs. |
| 2 | 53.6 lbs. |
| 3 | 52.2 lbs. |
| 4 | 57.5 lbs. |
| 5 | 53.7 lbs. |
| 6 | 53.4 lbs. |
| 7 | 54.2 lbs. |
| 8 | 53.4 lbs. |
| 9 | 53.7 lbs. |
| 10 | 51.7 lbs. |

The statistical characterization of the test results provide: an average forward tip resistance of 53.74 lbs.; a standard deviation of 1.53 lbs.; a coefficient of variation of 2.86% and a balance angle of 36.65°.

Without the baseplate 10 attached to the cabinet 20, as shown in FIG. 8b, the following test data was obtained:

TABLE 6

| Trial No. | Pull Force, to tip |
|---|---|
| 1 | 18.3 lbs. |
| 2 | 18.0 lbs. |
| 3 | 19.5 lbs. |
| 4 | 18.5 lbs. |
| 5 | 18.9 lbs. |
| 6 | 18.8 lbs. |
| 7 | 18.5 lbs. |
| 8 | 19.1 lbs. |
| 9 | 19.0 lbs. |
| 10 | 18.6 lbs. |

The statistical characterization of the test results provide: an average forward tip resistance of 18.72 lbs.; a standard deviation of 0.432 lbs.; a coefficient of variation of 2.3% and a balance angle of 15.5°.

From these results, it is shown that the baseplate 10 of this invention provides significant improvement in the forward tip resistance.

Test 4: Loaded Drawer with and without a ¼″ Steel Baseplate:

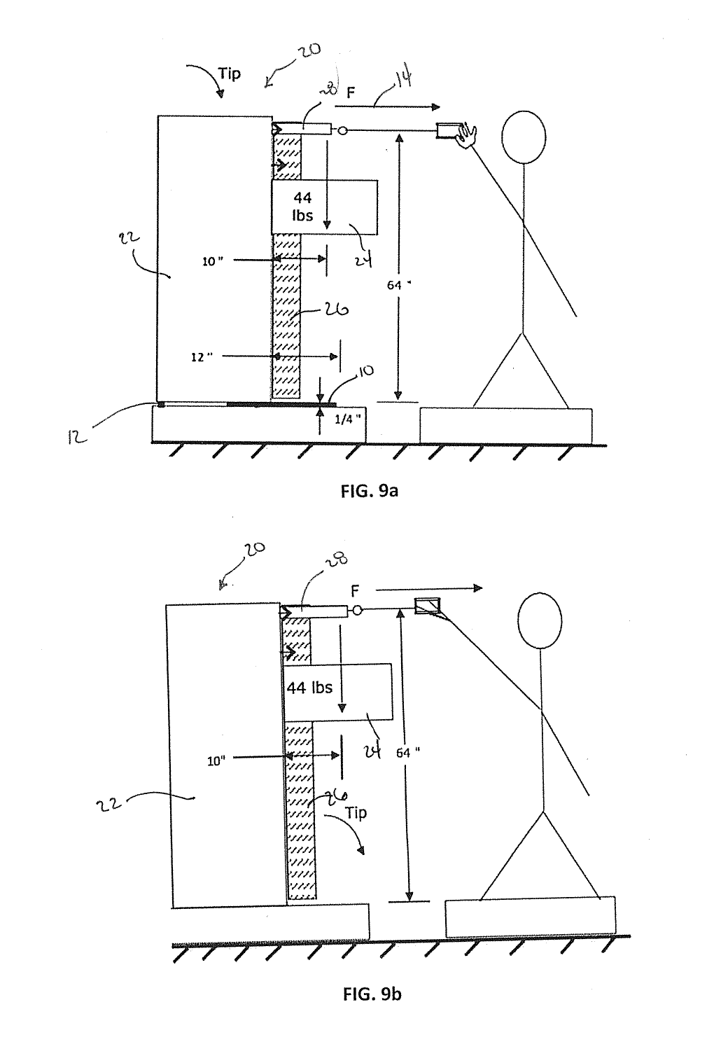

FIGS. 9a-b, show a schematic representation of an experiment illustrating an embodiment of the baseplate 10 of this invention. In this experiment, the same cabinet as tested in Test 1 was tested. In FIG. 9a, a steel baseplate 10 with a thickness of ¼ inch was attached to the bottom of the cabinet 20 with 12 inches extending from the front of the cabinet. Test conditions included: a level, carpeted surface; the wardrobe door open; the lift-up drawer open and fully extended; a ¼ inch steel base plate; the top drawer open and loaded with 44 lbs. centered 10 inches from the housing; the remaining drawers closed and empty; and a calibrated dynamometer. A tipping force 14 was applied to the cabinet 20 at 64 inches off the ground.

With the baseplate 10 attached to the cabinet 20, as shown in FIG. 9a, the following test data was obtained:

TABLE 7

| Trial No. | Pull Force, to tip |
|---|---|
| 1 | 44.8 lbs. |
| 2 | 49.7 lbs. |
| 3 | 50.2 lbs. |
| 4 | 48.4 lbs. |
| 5 | 48.3 lbs. |
| 6 | 50.3 lbs. |
| 7 | 47.7 lbs. |
| 8 | 47.5 lbs. |
| 9 | 48.2 lbs. |
| 10 | 51.3 lbs. |

The statistical characterization of the test results provide: an average forward tip resistance of 48.64 lbs.; a standard deviation of 1.85 lbs.; a coefficient of variation of 3.80% and a balance angle of 30.0°.

Without the baseplate 10 attached to the cabinet 20, as shown in FIG. 9b, the following test data was obtained:

TABLE 8

| Trial No. | Pull Force, to tip |
|---|---|
| 1 | 9.1 lbs. |
| 2 | 9.0 lbs. |
| 3 | 9.2 lbs. |
| 4 | 9.3 lbs. |
| 5 | 9.7 lbs. |
| 6 | 9.5 lbs. |
| 7 | 9.7 lbs. |
| 8 | 9.6 lbs. |
| 9 | 9.7 lbs. |
| 10 | 9.1 lbs. |

The statistical characterization of the test results provide: an average forward tip resistance of 9.39 lbs.; a standard deviation of 0.281 lbs.; a coefficient of variation of 2.99% and a balance angle of 9.0°.

From these results, it is shown that the baseplate 10 of this invention provides significant improvement in the forward tip resistance. Thus, the present invention provides a baseplate that can be retrofit to a file cabinet to prevent the cabinet from tipping over and possibly causing injuries.

While in the foregoing specification this invention has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles of the invention.

What is claimed is:

1. An anti-tip retro fit kit for a file cabinet comprising:
a baseplate connectable to a bottom of the file cabinet, wherein the baseplate extends beyond a footprint of the file cabinet to shift an axis of rotation to in front of the cabinet.

2. The anti-tip retro fit kit of claim 1, wherein a material of the baseplate comprises steel.

3. The anti-tip retro fit kit of claim 1, wherein the baseplate comprises a thickness ranging from ⅛ inch to 1 inch.

4. The anti-tip retro fit kit of claim 1, further including a leveling screw positioned on the bottom of the file cabinet opposite to the baseplate.

5. A tip resistant cabinet comprising:
a housing including a drawer and a footprint; and
a baseplate connected to a bottom of the housing, wherein the baseplate extends beyond an edge of the footprint of the file cabinet to shift an axis of rotation to in front of the cabinet.

6. The tip resistant cabinet of claim 5, wherein a material of the baseplate comprises steel.

7. The tip resistant cabinet of claim 5, wherein the baseplate comprises a thickness ranging from ⅛ inch to 1 inch.

8. The tip resistant cabinet of claim 5, further including a leveling screw positioned on the bottom of the housing opposite to the baseplate.
